(19) United States
(12) Patent Application Publication
(10) Pub. No.: US 2025/0042121 A1
(43) Pub. Date: Feb. 6, 2025

(54) CORE CORRECTOR

(71) Applicant: Encore Packaging LLC, Lake Villa, IL (US)

(72) Inventors: Stephenson Nelson, Gurnee, IL (US); Timothy H. Nelson, Winnetka, IL (US)

(21) Appl. No.: 18/794,019

(22) Filed: Aug. 5, 2024

Related U.S. Application Data
(60) Provisional application No. 63/517,494, filed on Aug. 3, 2023.

(51) Int. Cl. B31F 7/00

(52) U.S. Cl. CPC B31F 7/008; B31F 7/002

(57) ABSTRACT

A strapping core corrector comprising a first arcuate side, a second arcuate side, at least open slide coupled therebetween, and a linear expansion member is provided. The first arcuate side and the second arcuate side include a flange and a collar disposed substantially perpendicular to one another. The at least one slide is coupled to an end of the first arcuate side and the second arcuate side. The linear expansion member is coupled to the first arcuate side and the second arcuate side and it configured to expand the first arcuate side and the second arcuate side to correct a deformed core of a roll of strapping.

### CROSS REFERENCE TO RELATED APPLICATION

This application claims the benefit of U.S. Provisional Patent Application No. 63/517,494, filed Aug. 3, 2023, which is incorporated herein by reference in its entirety.

### TECHNICAL FIELD

This disclosure relates generally to a core corrector for rolls of package strapping material including a core which the strapping material is disposed around.

### BACKGROUND

Package strapping material generally includes a core which the strapping material is wrapped or coiled around. The core of the strapping material is typically made of a corrugated material, such as cardboard, and may become deformed during shipping. The deformation results in a roll that cannot be placed on a strapping dispenser, and in turn, must be used for a different purpose, or entirely disposed of.

### BRIEF DESCRIPTION OF THE DRAWINGS

Disclosed herein are embodiments of apparatuses pertaining to core correctors including and/or utilizing slides and an expansion means to correct deformed cores. This description includes drawings, wherein:

FIG. 1 is a perspective view of a core corrector in accordance with various embodiments.

FIG. 2 is a top view of a core corrector in accordance with various embodiments.

FIG. 3 is a bottom perspective view of a core corrector in accordance with various embodiments.

FIG. 4 is a bottom view of a core corrector in accordance with various embodiments.

FIG. 5 is a top side perspective view of a core corrector in accordance with various embodiments.

FIG. 6 is a bottom side perspective view of a core corrector in accordance with various embodiments.

FIG. 7 is a top side perspective view of a core corrector in accordance with various embodiments.

FIG. 8 is a perspective exploded view of a quick expansion member in accordance with various embodiments.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Described herein are apparatuses that are useful for correcting cores of strapping material. Such apparatuses also may assist with carrying the strapping material, such as rolls of plastic of metal banding, as well as reducing waste of strapping material.

Whereas shipping strapping or banding material typically includes shipping the material disposed or wound around a core, such as a corrugated material core, the core may be damaged during shipping such that the core is no longer round, i.e., circular. This may cause issues when the roll is loaded onto a strapping material dispenser as the strapping material dispensers require a substantially circular core to fit onto the dispenser. If the strapping material cannot fit onto the dispenser due to the deformed core, the whole roll may need to be discarded if there is no other use for the strapping.

Generally speaking, pursuant to these various embodiments described herein, a core corrector includes a first arcuate side, a second arcuate side, at least one slide movably coupled to the first arcuate side and the second arcuate side, and a linear expansion means. The first arcuate side and the second arcuate side both include a flange and a collar coupled together and disposed substantially perpendicular to one another. The at least one slide may be movably coupled to an end of each of the first arcuate side and the second arcuate side. The expansion means is coupled to the first arcuate side and the second arcuate side. The expansion means may, in accordance with one embodiment, be coupled to the middle of the first arcuate side and the second arcuate side. So configured, the expansion means and at least one slide may be substantially parallel to one another.

In some configurations, the linear expansion means includes a rotatable expansion member to provide the outward force on the deformed core. In some configurations, the linear expansion means may include a rack and pinion system including a lever to provide the outward force on the deformed core. In yet further embodiments, a quick expansion member may be utilized. The quick expansion member may be used to provide a loose fit, or a rough fit, of the core corrector on the deformed core. So configured, the linear expansion means does not need to be used to expand the core corrector out to initially contact the core. For example, in an embodiment including a rotatable expansion means and a quick expansion member, the core corrector can be placed inside of the deformed core. Instead of a user rotating the expansion means to make an initial contact with the deformed core, which may be multiple rotations, the user may utilize the quick expansion member to slide the first arcuate side and the second arcuate side to make the initial contact, then use the expansion means to provide the outward force on the deformed core by expanding the first arcuate side and the second arcuate side away from one another. Similarly, once the core corrector has corrected the deformed core by providing the outward force applied by the expansion means, the quick expansion member can be used to quickly return the core corrector to a retracted position.

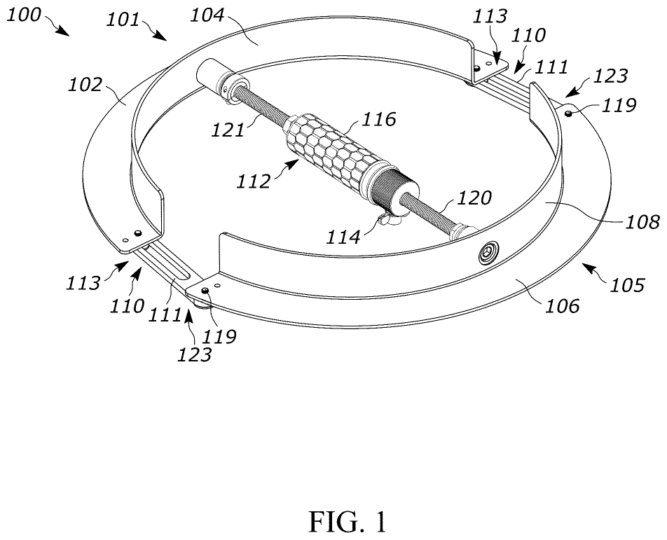

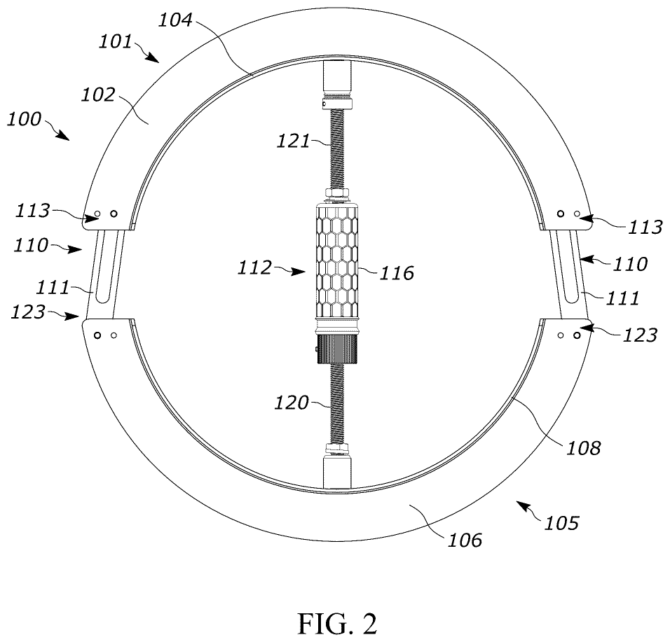

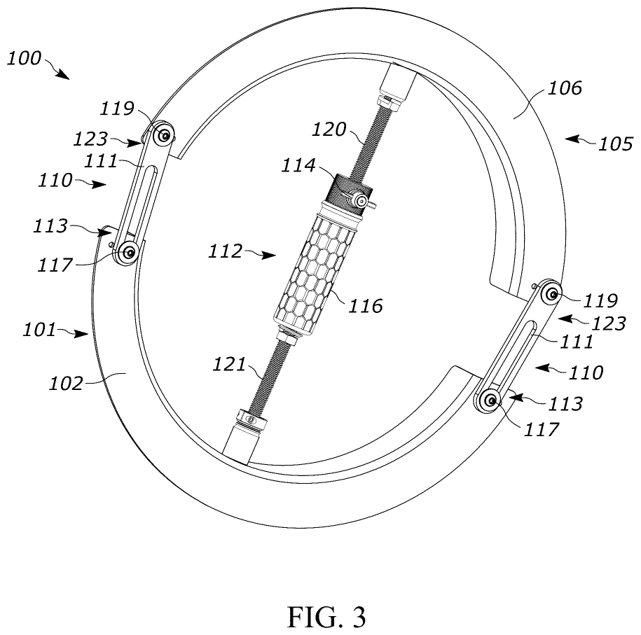

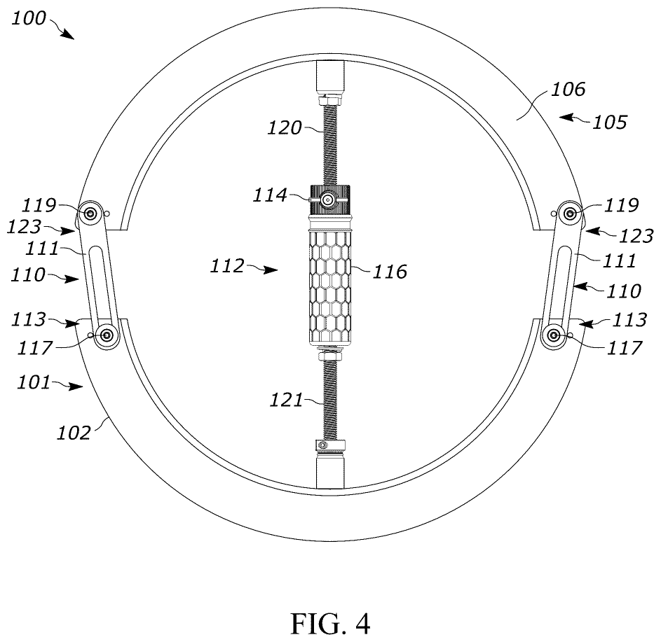

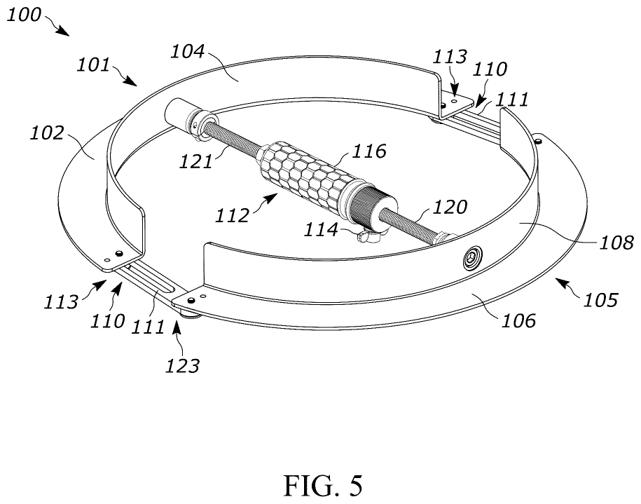

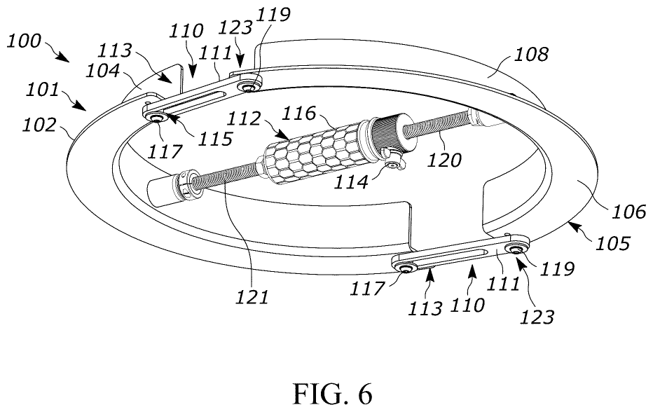

Referring now to the drawings, wherein identical numerals indicate the same elements throughout the figures, FIGS. 1 to 6 illustrate an example core corrector 100 in accord with some embodiments. The core corrector 100 includes a first arcuate side 101 including a first flange 102 and a first collar 104, a second arcuate side 105 including a second flange 106 and a second collar 108, at least one slide 110, a linear expansion means 112, and a quick expansion member 114. The core corrector 100 may be metal, plastic, carbon fiber, or another material strong enough to support the force provided to the core of the roll of strapping. The core corrector 100 may be used on different sized cores of strapping material. For example, the deformed core may be between 8 and 24 inches in diameter and 2 to 8 inches in width. Accordingly, the first flange 102 and the second flange 106 may be between 2 and 4 inches long, and the first collar 104 and second collar 108 may be between 2 and 8 inches wide.

The core corrector 100 may be substantially circular in a non-deployed state. As used herein, a non-deployed state, or a retracted position, includes the first arcuate side 101 and the second arcuate side 105 substantially close together and not extended on the at least one slide 110. Conversely, when the core corrector 100 is in a deployed state, or an extended state, the core corrector may be substantially ovular. As used herein, the deployed or extended state includes the first arcuate side 101 and the second arcuate side 105 at least partially in contact with the deformed core and/or the first arcuate side 101 and the second arcuate side 105 are substantially apart from one another extended away from one another of the at least one slide 110.

In the illustrated example, the slide 110 is a substantially flat member 111 defining at one end a slot 113 therein sized to receive a post 115 connected to and extending from the first arcuate side 101 such that the post 115 may slide along the length of the slot 113. The post 115 includes a flange 117 that prevents the post 115 from sliding laterally out of the slide 110. For example, the post 115 may be a screw threadingly connected to the first arcuate side 101, and the flange 117 may be the screw's head and/or a washer disposed between the screw's head and the slide 110. A fastener 119 secures a second end 123 of the slide 110 opposite of the first end to the second arcuate side 105. In one example, the fastener 119 allows rotation of the slide 110 relative to the second arcuate side 105. In another example, fastener 119 is disposed within a second slot in a manner similar to the post 115 for the first arcuate side 101 or within the same slot 113. The slide 110 allows for relative movement between the first arcuate side 101 and the second arcuate side 105 toward each other to permit placement within, for example, a misshapen strapping core and then movement away from each other to reshape the core.

The first arcuate side 101 includes the first flange 102 and the first collar 104. The first flange 102 and the first collar 104 may be substantially perpendicular to one another. Similarly, the second arcuate side 105 includes the second flange 106 and the second collar 108. The second flange 106 and the second collar 108 are substantially perpendicular to one another. The first collar 104 and the second collar 108, when deployed, make contact with an inside portion of the deformed core. The first flange 102 and the second flange 106 may contact both a portion of the deformed core and the strapping material wrapped around the core. An end of one of the first flange 102 or the second flange 106 may be fixed to the at least one slide 110. The other may include a fastener placed inside of the at least one slide 110 and permitted to be slidably or movably coupled to the at least one slide 110 such that the core corrector 100 can expand and retract.

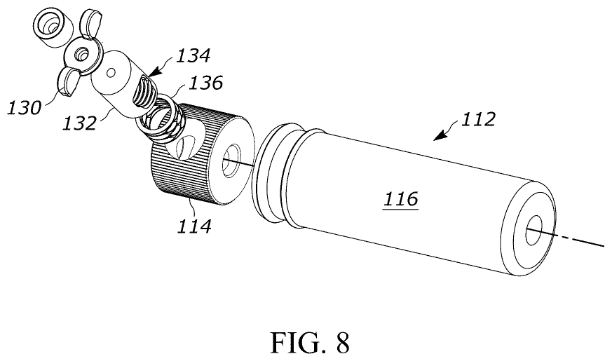

The linear expansion means 112 is disposed substantially in the middle of the core corrector 100, and in turn, substantially in the middle of the first arcuate side 101 and the second arcuate side 105 along the first collar 104 and the second collar 108. Additionally, the linear expansion means 112 may be substantially parallel to the at least one slide 110. The linear expansion means 112 may be fastened and fixedly attached to the first collar 104 and the second collar 108. The linear expansion means 112 may be coupled to the first collar 104 and the second collar 108 via support members 120 and 121. The support members 120 and 121 may be, for example, threaded rods or posts sufficient to support the linear expansion means 112 and direct the force for expanding the first and second arcuate sides 101 and 105. In the illustrated example, the user rotates an outer casing 116 connected to or including a spline (see, for example, pin 132 with threads 134 of FIG. 8) so as to drive the threaded rod 120 linearly outwardly, thus effecting movement of the second arcuate side 105 away from the first arcuate side 101. A second end of the outer casing 116 is rotatably connected at an end opposite of the spline to the second support member 121, for example, with wheel bearings, or fixedly connected to the second support member 121 where the second support member 121 is rotatably connected to the first arcuate side 101. The second support 121 member may be rotatably connected to both the outer casing 116 and the first arcuate side 101.

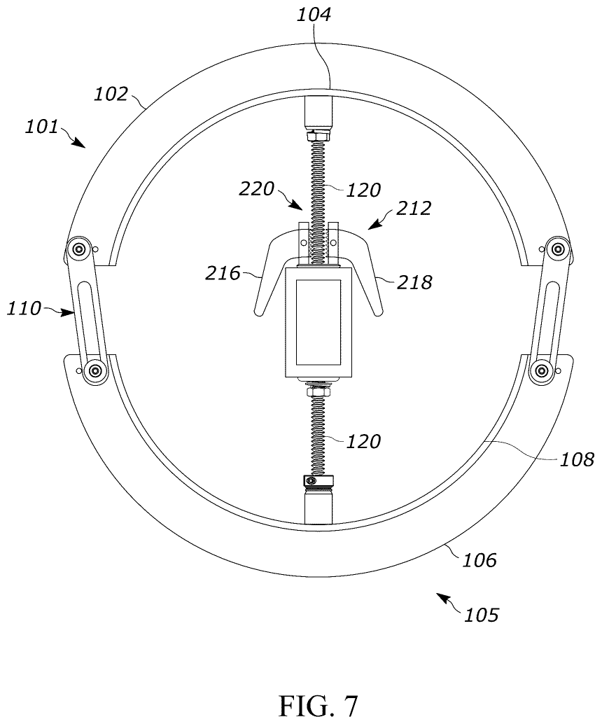

In another example, the linear expansion means 112 includes a rod including gears or teeth designed to engage a linear motion rack and pinion or a flat gear. In some embodiments, in a linear expansion means, a two lever system may be used including linkages and/or gears to provide the outward force. In yet further embodiments, there are multiple support members 120, such as one connected to each end of the linear expansion means 112 and/or the quick expansion member 114. One such example is provided in FIG. 7, illustrating an additional embodiment of the core corrector 200. The core corrector 200, similar to the core corrector 100, includes the first arcuate side 101, second arcuate side 105, first flange 102, second flange 106, first collar 104, second collar 108, at least one slide 110, and quick expansion member 114. The core corrector 200 operates similar to the core corrector 100, however, the linear expansion means 212 is a lever and flat gear based system, as opposed to the rotational based linear expansion means described above with reference to the core corrector 100.

The core corrector 200 includes a first lever 216 and a second lever 218. The first lever 216 and the second lever 218 are coupled to the linear expansion means 212 via pins 217. The first lever 216 and the second lever 218 are rotatable about the pins 217 to engage the flat gear 220. Engaging the first lever 216 and the second lever 218 with the flat gear 220 provides the outward force onto the deformed core. This system may be a rack and pinion based gear system providing the outward force.

In some embodiments, the linear expansion means 112 includes a motor configured to provide the linear expansion force onto the deformed core. Additionally or alternatively, the linear expansion means 112 includes an actuator and drive, including mechanical and manual actuators and drives, to provide the outward force onto the deformed core. The linear expansion means 112 described herein may be used to provide a linear expansion means to the deformed core. The methods and means described herein are non-limiting examples of these means, and those skilled in the art will understand additional and alternative methods and means may be used to provide the outward force to the deformed core and this outward force is substantially linear in nature.

The linear expansion means 112 may include a silicone or plastic covering over the member so a user can grab the linear expansion means 112 and expand the core corrector 100. Additionally, the linear expansion means 112 may be used as a handle to move and/or carry the roll of strapping when the core corrector 100 is in the deployed state. This can be used, for instance, for carrying the core corrector 100 and the roll of strapping to the dispenser to be placed on. The linear expansion means 112 may also be textured to provide additional grip for the core corrector 100.

The quick expansion member 114 is coupled to the linear expansion means 112. The quick expansion member 114, as discussed above, allows for quick expansion and retracting of the core corrector 100. The quick expansion may reduce the amount of time to correct the deformed core. The quick expansion member 114 may include a fastener to engage and disengage the function of the quick expansion member 114. In some embodiments, the fastener may include a wingnut.

In some embodiments, the quick expansion member 114 may temporarily disengage the linear expansion means 112 such that the core corrector 100 may be quickly expanded and contracted. In doing so, the first arcuate side 101 and the second arcuate side 105 may make an initial contact with the deformed core, however, in the quick expansion, the core corrector 100 may not provide sufficient outward force to correct the deformed core. In this instant embodiment, the disengagement of the linear expansion means 112 may be manual or automatic. Where the disengagement of the linear expansion means 112 is manual, moving the fastener engages the quick expansion member 114 while simultaneously disengaging the linear expansion means 112. Conversely, where the disengagement of the linear expansion means 112 is automatic, movement of the quick expansion member 114 automatically disengages the linear expansion means 112 without the need to move the fastener. In other embodiments, the quick expansion member 114 and linear expansion means 112 function at the same time, i.e., when using the quick expansion member 114 the linear expansion means 112 remains engaged.

Referring to the example of FIG. 8, the quick expansion member 114 includes a wing nut 130, a pin 132, and a spring 136. The quick expansion member 114 is coupled to the linear expansion means 112. As stated above, the linear expansion means 112 is connected to the support members 120 and 121 on each end, with one of the ends of the linear expansion means 112 including the quick expansion member 114. The support member 121 coupled to the end including the quick expansion member 114 extends at least partially through the quick expansion member 114. The quick expansion member 114 includes a wingnut 130 mounted to provide a force onto the pin 132. The spring 136 biases the pin's 132 threads 134 to threadingly engage the support member 121. In other words, the pin's 132 threads 134 act as teeth to engage the threads of the support member 121. When the pin 132 is engaged with the support member 120, the quick expansion member 114 may be utilized as part of the linear expansion means 114 as described above. To disengage the quick expansion member 114, the wingnut 130 is rotated to move the pin's threads 134 to disengage from the support member 121, thereby allowing a user to simply slide the first arcuate side 101 and the second arcuate side 105 apart. Then, the wingnut 130 can be rotated to allow the pin's 132 threads 134 to re-engage the support member 121 and allow use of the linear expansion features described above.

In use, a deformed core of strapping material is provided, as noted above, this may be due to movement during shipping causing the roll of strapping material to have a non-circular core, as needed by strapping dispensers. To correct the deformed core, the core corrector 100 is placed inside of the deformed core. At this stage, the core corrector 100 is in the non-deployed, or retracted position, with the first arcuate side 101 and the second arcuate side 105 closer to one another. The user can utilize the quick expansion member 114 to expand the core corrector 100 such that the first arcuate side 101 and the second arcuate side 105 make an initial contact with the deformed core. As stated above, this contact does not provide sufficient outward force to correct the deformed core.

The linear expansion means 112 then can be used to expand the first arcuate side 101 and the second arcuate side 105 to provide sufficient outward force to correct the deformed core to return the deformed core back to a substantially circular shape. The core corrector 100 can be disengaged and removed from the deformed core, or the core including the core corrector 100 being utilized as a handle supporting the core corrector 100 and the core with the associated strapping. As such, the core corrector 100 may be used to carry the core and strapping for placement on a dispenser. The above steps may be performed utilizing the different embodiments discussed above.

What is claimed is:

1. A strapping core corrector comprising:
a first arcuate side including a first flange coupled substantially perpendicularly to a first collar;
a second arcuate side including a second flange coupled substantially perpendicularly to a second collar;
at least one slide coupled to an end of the first arcuate side and an end of the second arcuate side, wherein the at least one slide is movably coupled to one or both of the first arcuate side and the second arcuate side, wherein the first arcuate side couples to the second arcuate side via the at least one slide in a manner in which the first flange and the second flange are approximately parallel and the first collar and the second collar are approximately parallel in about a same plane; and
a linear expansion means operatively coupled to the first arcuate side and the second arcuate side, wherein the linear expansion means is configured to apply a force to the first arcuate side and to the second arcuate side to bias the first arcuate side away from the second arcuate side.

2. The strapping core corrector of claim 1 further comprising a quick expansion member configured to temporarily disengage a shaft of the linear expansion means to allow manual movement of the first arcuate side away from the second arcuate side.

3. The strapping core corrector of claim 2 wherein the quick expansion member comprises a wing nut and a pin including threads disposed on one side of the pin.

4. The strapping core corrector of claim 2 wherein the quick expansion member comprises a threaded knob and a pin including threads disposed on one side of the pin.

5. The strapping core corrector of claim 1 wherein the linear expansion means comprises at least one threaded shaft having a first threaded shaft end rotatably connected to one of the first arcuate side or the second arcuate side and a second threaded shaft end connected to a spline such that rotation of the spline in a first direction biases the first arcuate side away from the second arcuate side.

6. The strapping core corrector of claim 1 wherein the linear expansion means comprises a rack and pinion.

7. The strapping core corrector of claim 1 wherein the at least one slide is fixedly coupled to one of the first arcuate side or the second arcuate side.

8. The strapping core corrector of claim 7 wherein the at least one slide is slidably coupled to another of the one of the first arcuate side or the second arcuate side.

9. The strapping core corrector of claim 1 wherein the first arcuate side and the second arcuate side are connected to be substantially circular.

10. A method comprising:
placing a core corrector inside a deformed core of a roll of strapping;
utilizing a quick expansion member and at least one slide coupled to a first arcuate side and a second arcuate side to slide the first arcuate side and the second arcuate side into contact with the deformed core to provide an initial fit of the core corrector on the deformed core;
utilizing a linear expansion means operatively coupled to the first arcuate side and the second arcuate side to provide a biased fit of the core corrector on the deformed core; and
expanding the first arcuate side from the second arcuate side to correct the deformed core.

11. The method of claim 10 wherein the expanding the first arcuate side from the second arcuate side to correct the deformed core comprises rotating the expansion member to expand the first arcuate side and the second arcuate side.

12. The method of claim 10 wherein the expanding the first arcuate side and the second arcuate side to correct the deformed core comprises applying linear force by the expansion member to expand the first arcuate side from the second arcuate side.

13. The method of claim 10 wherein the utilizing the quick expansion member comprises the quick expansion member automatically disengaging to effect manual expansion of the linear expansion means.

14. The method of claim 10 wherein the utilizing the quick expansion member comprises manually engaging and disengaging the quick expansion member.
